(19) United States
(12) Patent Application Publication
(10) Pub. No.: US 2025/0081029 A1
(43) Pub. Date: Mar. 6, 2025

(54) METHOD AND APPARATUS FOR BUFFER STATUS REPORTING

(71) Applicant: LENOVO (BEIJING) LIMITED, Beijing (CN)

(72) Inventors: Yibin Zhuo, Beijing (CN); Lianhai Wu, Beijing (CN); Mingzeng Dai, Shanghai (CN); Le Yan, Shanghai (CN)

(21) Appl. No.: 18/293,055

(22) PCT Filed: Jul. 28, 2021
(86) PCT No.: PCT/CN2021/108938

§ 371 Date: Jan. 29, 2024

(51) Int. Cl. H04W 28/02

(52) U.S. Cl. CPC H04W 28/0278

(57) ABSTRACT

Embodiments of the present disclosure relate to buffer status reporting. According to some embodiments of the disclosure, a method performed by a wireless node may include: receiving a radio resource control (RRC) message configuring one or more logical channels (LCHs) of the wireless node, wherein the RRC message comprises one or more logical channel group (LCG) IDs corresponding to the one or more LCHs; generating a first buffer status reporting (BSR) medium access control (MAC) control element (CE) based on the received RRC message; and transmitting the first BSR MAC CE to a network node.

### TECHNICAL FIELD

Embodiments of the present disclosure generally relate to wireless communication technology, and more particularly to buffer status reporting (BSR) in a wireless communication system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In wireless communication systems, a buffer status reporting (BSR) procedure is used by a user equipment (UE) to provide the serving BS with information about uplink (UL) data volume in the medium access control (MAC) entity. In the integrated access and backhaul (IAB) networks, the BSR may be used by an IAB node (or IAB-MT) to provide its parent node(s) (e.g., the serving BS or another IAB node) with the information about UL data volume in the MAC entity. In addition, a pre-emptive buffer status reporting (pre-emptive BSR) procedure is used by an IAB node to provide its parent node(s) with the information about the amount of the data expected to arrive at the IAB node from its child node(s) and/or UE(s) connected to it. There is a need for efficiently transmitting the BSR or pre-emptive BSR in wireless communication systems.

### SUMMARY

Some embodiments of the present disclosure provide a method performed by a wireless node. The method may include: receiving a radio resource control (RRC) message configuring a logical channel group (LCG) ID for a logical channel (LCH) of the wireless node; generating a first buffer status reporting (BSR) medium access control (MAC) control element (CE) based on the RRC message; and transmitting the first BSR MAC CE.

Some embodiments of the present disclosure provide a method performed by a wireless node. The method may include: generating a first buffer status reporting (BSR) medium access control (MAC) control element (CE), wherein the first BSR MAC CE may include one or more logical channel group (LCG) group (LCGG) fields, and each of the one or more LCGG fields may indicate a presence or absence of a corresponding group of LCG fields in the first BSR MAC CE; and transmitting the first BSR MAC CE to a network node. The number of the one or more LCGG fields may be based on the maximum number of LCG IDs and the number of LCG IDs an LCGG associated with.

An LCGG field having a first value may indicate that at least one LCG associated with the LCGG field has data to be reported, and an LCGG field having a second value may indicate that all LCGs associated with the LCGG field do not have data to be reported.

In response to a first LCGG field of the one or more LCGG fields having the first value, the first BSR MAC CE may further include a first group of LCG fields. Each LCG field of the first group of LCG fields may be associated with a corresponding LCG ID and may indicate a presence or absence of a buffer size field of the corresponding LCG ID in the first BSR MAC CE. The buffer size field may indicate: an amount of data available across all LCHs associated with the corresponding LCG ID, or an amount of data expected to arrive at all LCHs associated with the corresponding LCG ID.

In response to a first LCGG field of the one or more LCGG fields having the first value, the first BSR MAC CE may further include a first group of LCG fields. Each LCG field of the first group of LCG fields may be associated with a corresponding LCG ID and may indicate whether an LCG having the corresponding LCG ID has data available or not.

In some embodiments of the present disclosure, the method may further include: receiving a radio resource control (RRC) message configuring one or more logical channels (LCHs) of the wireless node, wherein the RRC message may include one or more LCG IDs corresponding to the one or more LCHs. Generating the first BSR MAC CE may include generating the first BSR MAC CE in response to: the number of LCG IDs configured for LCHs in the received RRC message being greater than a first threshold for LCG number; a value of a LCG ID configured for LCHs in the received RRC message being greater than a second threshold for LCG ID; or an information element of logicalChannelGroup configured for an LCH in the received RRC message having a maximum value greater than the second threshold for LCG ID.

Some embodiments of the present disclosure provide a method performed by a network node. The method may include: transmitting, to a wireless node, a radio resource control (RRC) message configuring one or more logical channels (LCHs) of the wireless node, wherein the RRC message may include one or more logical channel group (LCG) IDs corresponding to the one or more LCHs; and receiving, from the wireless node, a first buffer status reporting (BSR) medium access control (MAC) control element (CE), wherein the first BSR MAC CE may be based on the transmitted RRC message.

The first BSR MAC CE may include an LCG ID bitmap field, and the size of the LCG ID bitmap field may be variable based on the number of LCG IDs configured for LCHs in the RRC message. The LCG ID bitmap field may include one or more indicators, and the one or more indicators may be associated with the corresponding LCG IDs configured for the one or more LCHs in the RRC message.

In some embodiments of the present disclosure, the one or more indicators may be arranged according to an ascending order or a descending order of the values of the one or more LCG IDs configured for the corresponding one or more LCHs in the RRC message. In some embodiments of the present disclosure, each of the one or more indicators may indicate a presence or absence of a buffer size field for the corresponding LCG in the first BSR MAC CE. The buffer size field may indicate: an amount of data available across all LCHs associated with the corresponding LCG ID, or an amount of data expected to arrive at all the LCHs associated with the corresponding LCG ID. In some embodiments of the present disclosure, each of the one or more indicators may indicate whether an LCG having the corresponding LCG ID has data available or not.

The first BSR MAC CE may include one or more LCG fields, and the number of the LCG fields may be variable based on the number of LCG IDs configured for LCHs in the RRC message. The one or more LCG fields may be associated with the corresponding one or more LCG IDs configured for the one or more LCHs in the RRC message.

In some embodiments of the present disclosure, the one or more LCG fields may be arranged according to an ascending order or a descending order of the values of the one or more LCG IDs configured for the corresponding one or more LCHs in the RRC message. In some embodiments of the present disclosure, each of the one or more LCG fields may indicate a presence or absence of a buffer size field for the corresponding LCG in the first BSR MAC CE. The buffer size field may indicate: an amount of data available across all LCHs associated with the corresponding LCG ID, or an amount of data expected to arrive at all the LCHs associated with the corresponding LCG ID. In some embodiments of the present disclosure, each of the one or more LCG fields may indicate whether an LCG having the corresponding LCG ID has data available or not.

The first BSR MAC CE may further include at least one reserved bit such that a combination of the LCG ID bitmap field and the at least one reserved bit or a combination of the one or more LCG fields and the at least one reserved bit may be byte aligned.

In some embodiments of the present disclosure, receiving the first BSR MAC CE may include receiving the first BSR MAC CE in response to: the number of LCG IDs configured for LCHs in the RRC message being greater than a first threshold for LCG number; a value of an LCG ID configured for LCHs in the RRC message being greater than a second threshold for LCG ID; or an information element of logicalChannelGroup configured for an LCH in the RRC message having a maximum value greater than the second threshold for LCG ID.

Some embodiments of the present disclosure provide a method performed by a network node. The method may include: receiving, from a wireless node, a first buffer status reporting (BSR) medium access control (MAC) control element (CE), wherein the first BSR MAC CE may include one or more logical channel group (LCG) group (LCGG) fields, and each of the one or more LCGG fields may indicate a presence or absence of a corresponding group of LCG fields in the first BSR MAC CE.

In some embodiments of the present disclosure, the number of the one or more LCGG fields may be based on the maximum number of LCG IDs and the number of LCG IDs an LCGG associated with. In some embodiments of the present disclosure, an LCGG field having a first value may indicate that at least one LCG associated with the LCG field has data to be reported, and an LCGG field having a second value may indicate that all LCGs associated with the LCGG field do not have data to be reported.

In some embodiments of the present disclosure, in response to a first LCGG field of the one or more LCGG fields having the first value, the first BSR MAC CE may further include a first group of LCG fields. Each LCG field of the first group of LCG fields may be associated with a corresponding LCG ID and may indicate a presence or absence of a buffer size field of the corresponding LCG ID in the first BSR MAC CE. The buffer size field may indicate: an amount of data available across all LCHs associated with the corresponding LCG ID, or an amount of data expected to arrive at all LCHs associated with the corresponding LCG ID.

In some embodiments of the present disclosure, in response to a first LCGG field of the one or more LCGG fields having the first value, the first BSR MAC CE may further include a first group of LCG fields. Each LCG field of the first group of LCG fields may be associated with a corresponding LCG ID and may indicate whether an LCG having the corresponding LCG ID has data available or not.

In some embodiments of the present disclosure, the method may further include: transmitting a radio resource control (RRC) message configuring one or more logical channels (LCHs) of the wireless node, wherein the RRC message may include one or more LCG IDs corresponding to the one or more LCHs. Receiving the first BSR MAC CE may include receiving the first BSR MAC CE in response to: the number of LCG IDs configured for LCHs in the transmitted RRC message being greater than a first threshold for LCG number; a value of an LCG ID configured for LCHs in the transmitted RRC message being greater than a second threshold for LCG ID; or an information element of logicalChannelGroup configured for an LCH in the transmitted RRC message having a maximum value greater than the second threshold for LCG ID.

Some embodiments of the present disclosure provide a wireless node. The wireless node may include: a processor configured to generate a first buffer status reporting (BSR) medium access control (MAC) control element (CE), wherein the first BSR MAC CE may include one or more logical channel group (LCG) group (LCGG) fields, and each of the one or more LCGG fields may indicate a presence or absence of a corresponding group of LCG fields in the first BSR MAC CE; and a transceiver coupled to the processor, wherein the transceiver may be configured to transmit the first BSR MAC CE to a network node.

Some embodiments of the present disclosure provide a network node. The network node may include: a processor; and a transceiver coupled to the processor, wherein the transceiver may be configured to: transmit, to a wireless node, a radio resource control (RRC) message configuring one or more logical channels (LCHs) of the wireless node, wherein the RRC message may include one or more logical channel group (LCG) IDs corresponding to the one or more LCHs; and receive, from the wireless node, a first buffer status reporting (BSR) medium access control (MAC) control element (CE), wherein the first BSR MAC CE may be based on the transmitted RRC message.

Some embodiments of the present disclosure provide a network node. The network node may include: a processor; and a transceiver coupled to the processor, wherein the transceiver may be configured to: receive, from a wireless node, a first buffer status reporting (BSR) medium access control (MAC) control element (CE), wherein the first BSR MAC CE may include one or more logical channel group (LCG) group (LCGG) fields, and each of the one or more LCGG fields may indicate a presence or absence of a corresponding group of LCG fields in the first BSR MAC CE.

Some embodiments of the present disclosure provide a wireless node. According to some embodiments of the present disclosure, the wireless node may include: a transceiver; and a processor coupled to the transceiver, wherein the transceiver and the processor may interact with each other so as to perform a method according to some embodiments of the present disclosure.

Some embodiments of the present disclosure provide a network node. According to some embodiments of the present disclosure, the network node may include: a transceiver; and a processor coupled to the transceiver, wherein the transceiver and the processor may interact with each other so as to perform a method according to some embodiments of the present disclosure.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of a wireless communication system in accordance with some embodiments of the present disclosure;

FIGS. 3-9 illustrate exemplary BSR MAC CE formats in accordance with some embodiments of the present disclosure;

FIG. 10 illustrates a flow chart of an exemplary procedure of wireless communications in accordance with some embodiments of the present disclosure; and

FIG. 11 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

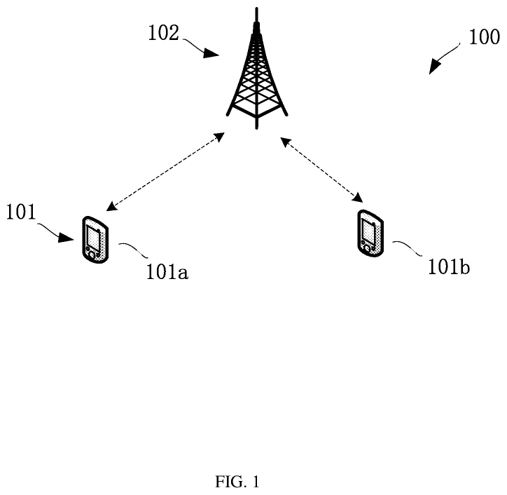

FIG. 1 illustrates a schematic diagram of a wireless communication system 100 in accordance with some embodiments of the present disclosure.

As shown in FIG. 1, the wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

Compared with the 4G communication system, the 5G communication system has raised more stringent requirements for various network performance indicators, for example, 1000-times capacity increase, wider coverage requirements, ultra-high reliability and ultra-low latency, etc. Considering the rich frequency resources of high-frequency carriers, the use of high-frequency small station deployments is becoming more and more popular in hotspot areas in order to meet the needs of 5G ultra-high capacity. However, high-frequency carriers have poor propagation characteristics, severe attenuation due to obstructions, and limited coverage. Therefore, the dense deployment of small stations is required. On the other hand, the deployment of optical fiber is difficult and costly for these small stations. Therefore, an economical and convenient backhaul scheme is needed. Integrated Access and Backhaul (IAB) technology, whose access link and backhaul link both use wireless transmission solutions to avoid fiber deployment, provides ideas for solving the above problems.

In an IAB network, a relay node (RN) or IAB node or a wireless backhaul node/device can provide wireless access services for UEs. That is, a UE can connect to an IAB donor relayed by one or more IAB nodes. And the IAB donor may also be called a donor node or a donor base station (e.g., DgNB, Donor gNodeB). In addition, the wireless link between an IAB donor and an IAB node, or the wireless link between different IAB nodes can be referred to as a “backhaul link.”

An IAB node may include an IAB mobile terminal (MT) part and an IAB distributed unit (DU) part. When an IAB node connects to its parent node (which may be another IAB node or an IAB donor), it can be regarded as a UE, i.e., the role of the MT. When an IAB node provides service to its child node (which may be another IAB node or a UE), it can be regarded as a network device, i.e., the role of the DU.

An IAB donor can be an access network element with a complete base station function, or an access network element with a separate form of a centralized unit (CU) and a distributed unit (DU). The IAB donor may be connected to the core network (for example, connected to the 5G core network (5GC)), and provide the wireless backhaul function for the IAB nodes. The CU of an IAB donor may be referred to as an “IAB donor-CU” (or directly referred to as a “CU”), and the DU of the IAB donor may be referred to as an “IAB donor-DU.” The IAB donor-CU may be separated into a control plane (CP) and a user plane (UP). For example, a CU may include one CU-CP and one or more CU-UPs.

Considering the small coverage of the high frequency band, in order to ensure the coverage performance of the network, multi-hop networking may be adopted in an IAB network. Taking into account the requirements of service transmission reliability, IAB nodes can support dual connectivity (DC) or multi-connectivity to improve the reliability of transmission, so as to deal with abnormal situations that may occur on the backhaul (BH) link, such as radio link failure (RLF) or blockage, load fluctuations, etc.

In the case where an IAB network supports multi-hop and dual-connection networking, there may be multiple transmission paths between the UE and the IAB donor. A transmission path may include multiple nodes, such as a UE, one or more IAB nodes, and an IAB donor (if the IAB donor is in the form of a separate CU and DU, it may also contain an IAB donor-DU and IAB donor-CU). Each IAB node may treat the neighboring node that provides backhaul services for it as a parent node (or parent IAB node), and each IAB node can be regarded as a child node (or child IAB node) of its parent node.

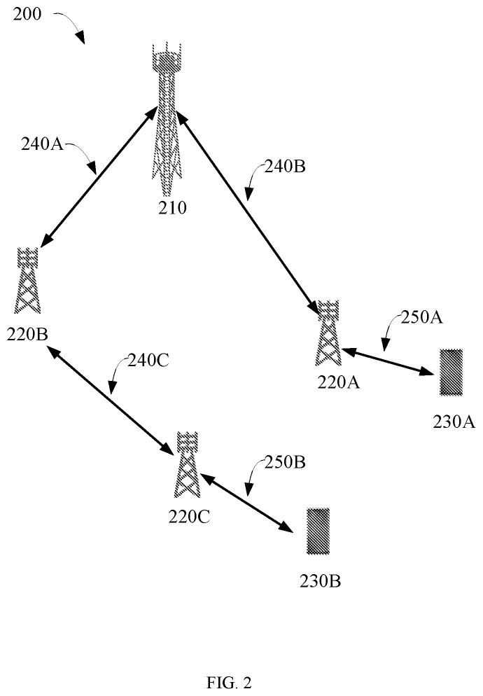

FIG. 2 illustrates a schematic diagram of a wireless communication system 200 in accordance with some embodiments of the present disclosure.

As shown in FIG. 2, the wireless communication system 200 may include a base station (e.g., IAB donor 210), some IAB nodes (e.g., IAB node 220A, IAB node 220B, and IAB node 220C), and some UEs (e.g., UE 230A and UE 230B).

Although a specific number of UEs, IAB nodes, and IAB donors is depicted in FIG. 2, it is contemplated that any number of UEs, IAB nodes, and IAB donors may be included in the wireless communication system 200.

Each of IAB donor 210, IAB node 220A, IAB node 220B, and IAB node 220C may be directly connected to one or more IAB nodes in accordance with some other embodiments of the present disclosure. Each of IAB donor 210, IAB node 220A, IAB node 220B, and IAB node 220C may be directly connected to one or more UEs in accordance with some other embodiments of the present disclosure.

Similar to wireless communication system 100 shown in FIG. 1, wireless communication system 200 may also be compatible with any type of network that is capable of sending and receiving wireless communication signals. UE 230A and UE 230B may be any type of device configured to operate and/or communicate in a wireless environment. For example, UE 230A and UE 230B may function as the UE(s) 101 shown in FIG. 1.

IAB donor 210 may be in communication with a core network (not shown in FIG. 2). The core network (CN) may include a plurality of core network components, such as a mobility management entity (MME) (not shown in FIG. 2) or an access and mobility management function (AMF) (not shown in FIG. 2). The CNs may serve as gateways for the UEs to access a public switched telephone network (PSTN) and/or other networks (not shown in FIG. 2).

Persons skilled in the art should understand that as technology develops and advances, the terminologies described in the present disclosure may change, but should not affect or limit the principles and spirit of the present disclosure.

Referring to FIG. 2, IAB node 220A and IAB node 220B can be directly connected to IAB donor 210. IAB donor 210 is a parent node of IAB node 220A and IAB node 220B. In other words, IAB node 220A and IAB node 220B are child IAB nodes of IAB donor 210. IAB node 220C can reach IAB donor 210 by hopping through IAB node 220B. IAB node 220B is a parent IAB node of IAB node 220C. In other words, IAB node 220C is a child IAB node of IAB node 220B.

UEs 230A and 230B can be connected to IAB nodes 220A and 220C, respectively. Uplink (UL) packets (e.g., data or signaling) from UE 230A or UE 230B can be transmitted to an IAB donor (e.g., IAB donor 210) via one or more IAB nodes, and then transmitted by the IAB donor to a mobile gateway device (such as the user plane function (UPF) in the 5GC). Downlink (DL) packets (e.g., data or signaling) can be transmitted from the IAB donor (e.g., IAB donor 210) after being received by the gateway device, and then transmitted to UE 230A or 230B through one or more IAB nodes.

For example, referring to FIG. 2, UE 230A may transmit UL data to IAB donor 210 or receive DL data therefrom via IAB node 220A. UE 230B may transmit UL data to IAB donor 210 or receive DL data therefrom via IAB node 220C and IAB node 220B.

In an IAB deployment such as the wireless communication system 200, the radio link between an IAB donor (e.g., IAB donor 210 in FIG. 2) and an IAB node or between two IAB nodes may be referred to as a backhaul link (BL). The radio link between an IAB donor (e.g., IAB donor 210 in FIG. 2) and a UE or between an IAB node and a UE may be referred to as an access link (AL). For example, in FIG. 2, radio links 240A to 240C are BLs and radio links 250A and 250B are ALs.

In a wireless communication system, such as wireless communication system 100 or 200, a wireless node such as a UE or an IAB node may perform a BSR procedure to provide the serving BS or its parent node(s) with information about UL data volume in its medium access control (MAC) entity. In addition, a wireless node such as an IAB node may perform a pre-emptive BSR procedure to provide its parent node(s) with the information about the amount of data expected to arrive at the wireless node from its child node(s) (e.g., UE(s) or a child IAB node) connected to it.

In some embodiments of the present disclosure, the wireless node may use a BSR MAC control element (CE) to report the UL data volume of one or more logical channel groups (LCGs) of the wireless node or the amount of data expected to arrive at the one or more LCGs. The maximum number of LCGs may be predefined in a standard(s). For example, the maximum number of LCGs may be predefined as eight. Each logical channel (LCH) of the wireless node may be allocated to a corresponding LCG using a higher layer parameter (e.g., the logicalChannelGroup information element (IE) as specified in 3GPP specifications). For example, a radio resource control (RRC) message may configure an LCG ID for an LCH of the wireless node. For instance, an RRC message may configure one or more LCHs of a wireless node and may include one or more LCG IDs corresponding to the one or more LCH. Different LCHs of the one or more LCHs may be configured with the same or different LCG IDs, i.e., associated with the same or different LCGs.

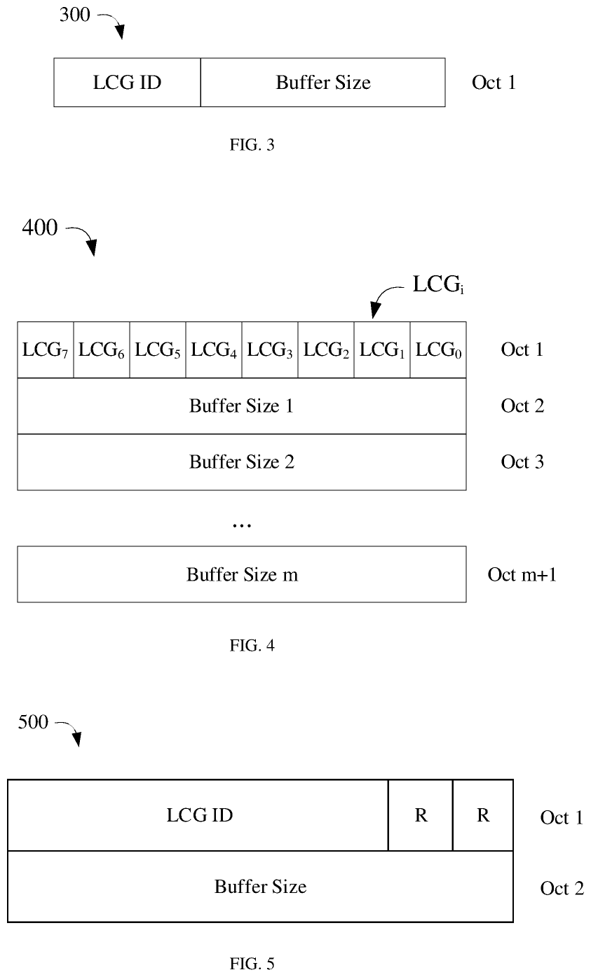

FIG. 3 illustrates an exemplary BSR MAC CE format 300 in accordance with some embodiments of the present disclosure. The BSR MAC CE format 300 is also referred to as a short BSR format or short truncated BSR format. The application scenarios of the short BSR format and short truncated BSR format are specified in 3GPP specifications. For example, when only one LCG has data available for transmission, a wireless node may choose the short BSR format to transmit the BSR.

As shown in FIG. 3, the BSR MAC CE format 300 can be octet aligned and can include 1 byte, which can be referred to as “Oct 1” in FIG. 3. The BSR MAC CE format 300 may include several fields such as a “LCG ID” field and a “Buffer Size” field. The “LCG ID” field may identify the LCG whose buffer status is being reported. The length of this field may be 3 bits. The “Buffer Size” field may identify the amount of data available across all LCHs of the LCG identified by the “LCG ID” field. The amount of data may be indicated in units of bytes. The size of the radio link control (RLC) headers and MAC subheaders are not considered in the buffer size computation. The length of this field may be 5 bits.

FIG. 4 illustrates an exemplary BSR MAC CE format 400 in accordance with some embodiments of the present disclosure. The BSR MAC CE format 400 is also referred to as a long BSR format, long truncated BSR format, or pre-emptive BSR format. The application scenarios of the long BSR format, long truncated BSR format, or pre-emptive BSR format are specified in 3GPP specifications. For example, when there are more than one LCG having data available for transmission, a wireless node may choose the long BSR format to transmit the BSR. When a pre-emptive BSR is triggered at a wireless node, the wireless node may choose the pre-emptive BSR format to transmit the pre-emptive BSR.

As shown in FIG. 4, the BSR MAC CE format 400 can be octet aligned and can include m+1 byte, which can be referred to as “Oct 1” to “Oct m+1” in FIG. 4. The BSR MAC CE format 400 may include several fields such as eight “LCGᵢ” fields (i.e., LCG₀ to LCG₇) and some “Buffer Size” fields.

For the long BSR format and pre-emptive BSR format, an “LCGᵢ” field may indicate the presence or absence of a “Buffer Size” field for the logical channel group i (where the value of i is an integer from 0 to 7). For example, the LCGᵢ field setting to 1 may indicate that the “Buffer Size” field for the logical channel group i is reported (i.e., included in the BSR MAC CE). The LCGᵢ field setting to 0 may indicate that the “Buffer Size” field for the logical channel group i is not reported. For the Long truncated BSR format, the “LCGᵢ” field may indicate whether logical channel group i has data available or not. For example, the LCGᵢ field setting to 1 may indicate that logical channel group i has data available. The LCGᵢ field setting to 0 may indicate that logical channel group i does not have data available.

For the long BSR format and long truncated BSR format, a “Buffer Size” field may identify the amount of data available across all LCHs of a corresponding LCG. The amount of data may be indicated in units of bytes. The size of the RLC headers and MAC subheaders are not considered in the buffer size computation. The length of a “Buffer Size” field for the long BSR format and the long truncated BSR format may be 8 bits. For the long truncated BSR format, the number of “Buffer Size” fields included is maximized, while not exceeding the number of padding bits.

For the long BSR format and long truncated BSR format, the “Buffer Size” fields may be included in an ascending (or descending) order based on the LCGᵢ. For example, assuming that the LCG₇, LCG₅, and LCG₃ fields indicate the “Buffer Size” fields for LCG 7, LCG 5, LCG 3 are reported, the BSR MAC CE may include three “Buffer Size” fields (e.g., Buffer Size field #7, Buffer Size field #5, and Buffer Size field #3) for LCG 7, LCG 5, LCG 3, respectively. The three “Buffer Size” fields may be arranged in an order of Buffer Size field #3, Buffer Size field #5, and Buffer Size field #7 in the BSR MAC CE (i.e., an ascending order of the IDs of the LCGs).

For the pre-emptive BSR format, the “Buffer Size” field may identify the amount of data expected to arrive at the IAB-MT of the node where the pre-emptive BSR is triggered and does not include the volume of data currently available in the IAB-MT. The pre-emptive BSR format may be identical to the long BSR format.

The BSR formats 300 and 400 as shown above can support a maximum number of 8 LCGs. As the maximum number of LCGs extends (for example, the maximum number of LCGs can be extended to up to 256), new BSR MAC CE formats may be required to support an extended LCG range.

FIG. 5 illustrates an exemplary BSR MAC CE format 500 in accordance with some embodiments of the present disclosure. The BSR MAC CE format 500 can be used as a short BSR format or short truncated BSR format, and are designed to meet the extension of the maximum number of LCGs.

As shown in FIG. 5, the BSR MAC CE format 500 can be octet aligned and can include a fixed size, for example, 2 bytes, which can be referred to as “Oct 1” and “Oct 2” in FIG. 5. The BSR MAC CE format 500 may include several fields such as a “LCG ID” field, one or more “R” fields (optional), and a “Buffer Size” field.

The “R” field may indicate a reserved bit(s) and may be set to 0. The “LCG ID” field may identify the LCG whose buffer status is being reported, for example, indicating a corresponding LCG ID. The length (or size) of the “LCG ID” field may be determined according to the maximum number of LCGs (or LCG IDs). Denoting the maximum number of LCGs as M, the length of the “LCG ID” field can be determined by log 2 (M). In the example of FIG. 5, it is assumed that the maximum number of LCGs is 64. Thus, the length of the “LCG ID” field is 6 bits, and the BSR MAC CE format 500 shows two “R” fields such that a combination of the “LCG ID” field and the “R” fields is byte aligned.

In some other embodiments of the present disclosure, the BSR MAC CE format 500 may include fewer or more “R” fields. For example, when the maximum number of LCGs is 256, the length of the “LCG ID” field is 8 bits, and no “R” field is included in the BSR MAC CE format 500. Although the “R” fields are added after the end of the “LCG ID” field in the example of FIG. 5, it should be appreciated by persons skilled in the art that the “R” fields may be positioned before the beginning the “LCG ID” field in some other embodiments of the present disclosure.

The “Buffer Size” field may identify the amount of data available across all LCHs of the LCG identified by the “LCG ID” field. The length of the “Buffer Size” field may be 8 bits. In some other embodiments of the present disclosure, the “Buffer Size” field may include more or fewer bits (e.g., 16 bits).

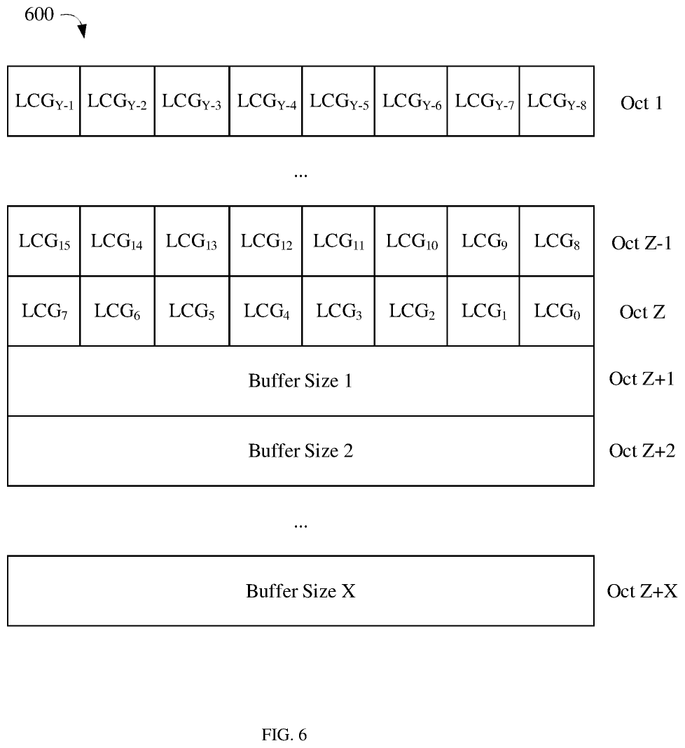

FIG. 6 illustrates an exemplary BSR MAC CE format 600 in accordance with some embodiments of the present disclosure. The BSR MAC CE format 600 can be used as long BSR format, long truncated BSR format, or pre-emptive BSR format, and are designed to meet the extension of the maximum number of LCGs.

As shown in FIG. 6, the BSR MAC CE format 600 can be octet aligned and can have a variable size. The BSR MAC CE format 600 may include several fields such as some “LCGᵢ” fields and some “Buffer Size” fields. For example, assuming that the maximum number of LCGs is Y, which is a multiple of 8, the BSR MAC CE format 600 may include Y “LCGᵢ” fields, including LCG₀ to LCG_{Y-1} as shown in FIG. 6. The Y “LCGᵢ” fields may occupy Z (i.e., Z=Y/8) bytes, which can be referred to as “Oct 1” to “Oct Z” in FIG. 6.

Although there are a plurality of “Buffer Size” fields in the example of FIG. 6, it should be appreciated by persons skilled in the art that the BSR MAC CE format 600 may not include any “Buffer Size” fields or may include only one “Buffer Size” field in some other embodiments of the present disclosure. For example, when the padding bits cannot accommodate a “Buffer Size” field or can at most accommodate one “Buffer Size” field.

In some other embodiments of the present disclosure, the maximum number of LCGs may not be a multiple of 8, the BSR MAC CE format 600 may further include at least one “R” field such that a combination of the “LCGᵢ” fields and the at least one “R” field is byte aligned. The at least one “R” field may be added after the end of all “LCGᵢ” fields or before any “LCGᵢ” fields (e.g., at the beginning of “Oct 1”).

The “LCGᵢ” field and “Buffer Size” field may have the same definitions as the corresponding fields described above with respect to FIG. 4. For example, the long BSR format and pre-emptive BSR format, an “LCGᵢ” field may indicate the presence or absence of a “Buffer Size” field for the logical channel group i (where the value of i is an integer from 0 to Y). For the Long truncated BSR format, the “LCGᵢ” field may indicate whether logical channel group i has data available or not.

Although the “LCGᵢ” fields are arranged according to the descending order of the LCG IDs in the example of FIG. 6, it should be appreciated by persons skilled in the art that the “LCGᵢ” field may be arranged according to any other method that can be conceived of by persons skilled in the art. In some examples, the “LCGᵢ” field may be arranged according to the ascending order of LCG IDs (for example, starting from LCG₀ and ending at LCG_{Y-1}) in some other embodiments of the present disclosure. In some examples, the “LCGᵢ” field may be arranged according to the following manner, “Oct 1” of the BSR format may start from LCG₇ and end at LCG₀, “Oct 2” of the format may start from LCG₁₅ and end at LCG₈, and so on.

For example, for the long BSR format and long truncated BSR format, a “Buffer Size” field may identify the amount of data available across all LCHs of a corresponding LCG. The amount of data may be indicated in units of bytes. The size of the RLC headers and MAC subheaders are not considered in the buffer size computation. The length of a “Buffer Size” field for the long BSR format and the long truncated BSR format may be 8 bits. For the long truncated BSR format, the number of “Buffer Size” fields included is maximized, while not exceeding the number of padding bits. For the long BSR format and long truncated BSR format, the “Buffer Size” fields may be included in an ascending (or descending) order based on the LCGᵢ.

For the pre-emptive BSR format, the “Buffer Size” field may identify the amount of data expected to arrive at the IAB-MT of the node where the pre-emptive BSR is triggered and does not include the volume of data currently available in the IAB-MT. For example, the “Buffer Size” field may indicate the amount of data expected to arrive at all the LCHs of a corresponding LCG. The length of a “Buffer Size” field for the pre-emptive BSR format may also be 8 bits. The “Buffer Size” fields may be included in an ascending (or descending) order based on the LCGᵢ.

Referring to FIG. 6, for a long BSR format, assuming that among the Y “LCGᵢ” field, X “LCGᵢ” fields indicate the presence of a “Buffer Size” field for the corresponding LCG, the BSR MAC CE format 600 may include X “Buffer Size” fields, which can occupy “Oct Z+1” to “Oct Z+X” in FIG. 6. The X “Buffer Size” fields may be arranged according to the ascending (or descending) order of the LCG IDs of the corresponding LCGs.

In the example of FIG. 6, since all the LCGs are directly enumerated in the BSR MAC CE format, the overhead for the LCGᵢ field in the BSR MAC CE could be large. For example, in the case that the maximum number of LCGs is 256, 32 bytes is required for the LCGᵢ fields. Embodiments of the present disclosure further provide enhanced solutions to reduce such overhead while meeting the extension of the maximum number of LCGs.

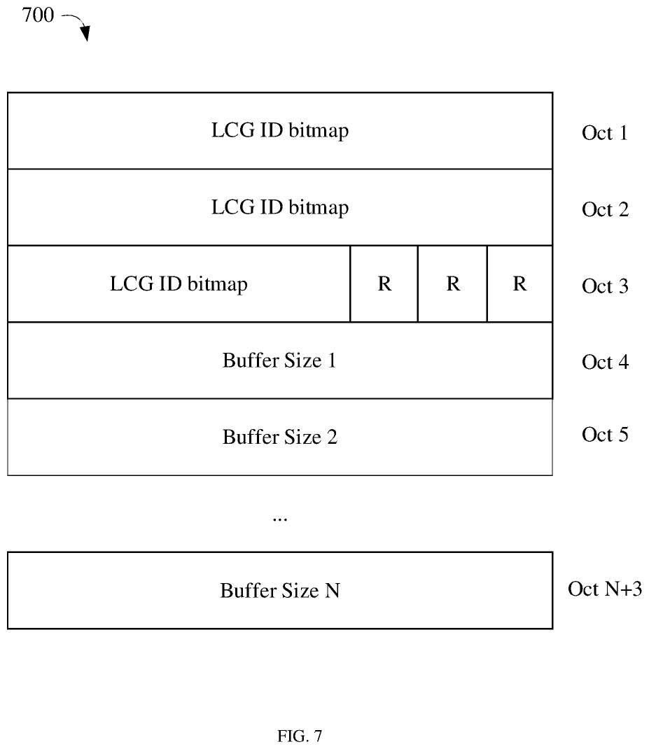

FIG. 7 illustrates an exemplary BSR MAC CE format 700 in accordance with some embodiments of the present disclosure. The BSR MAC CE format 700 can be used as a long BSR format, long truncated BSR format, or pre-emptive BSR format.

As shown in FIG. 7, the BSR MAC CE format 700 can be octet aligned and can have a variable size. The BSR MAC CE format 700 may include several fields such as a “LCG ID bitmap” field, one or more “R” fields (optional) and some “Buffer Size” fields.

Although there are a plurality of “Buffer Size” fields in the example of FIG. 7, it should be appreciated by persons skilled in the art that the BSR MAC CE format 700 may not include any “Buffer Size” fields or may include only one “Buffer Size” field in some other embodiments of the present disclosure. For example, when the padding bits cannot accommodate a “Buffer Size” field or can at most accommodate one “Buffer Size” field.

As stated above, an RRC message may configure an LCG ID for an LCH of a wireless node. The size of the “LCG ID bitmap” field can be variable based on the number of LCG IDs configured for LCHs in such RRC message. For example, although up to 64 LCGs may be supported (e.g., the LCG IDs may be indexed from 0 to 63 or 1 to 64), a wireless node may be configured with only 21 LCG IDs for its LCHs. The BSR MAC CE format 700 may include an “LCG ID bitmap” field having 21 bits, which occupies the first two bytes (denoted as “Oct 1” and “Oct 2” in FIG. 7) and the first 5 bits of the third byte (denoted as “Oct 3” in FIG. 7) of the BSR MAC CE format 700. The BSR MAC CE format 700 may further include three “R” fields such that a combination of the “LCG ID bitmap” field and the “R” fields is byte aligned.

In some other embodiments of the present disclosure, the BSR MAC CE format 700 may include fewer or more “R” fields. For example, when the number of LCG IDs which have been actually used to configure for the LCHs of the wireless node is a multiple of 8, no “R” field is included in the BSR MAC CE format 700. Although the “R” fields are added after the end of “LCG ID bitmap” field in the example of FIG. 7, it should be appreciated by persons skilled in the art that the “R” fields may be positioned before the beginning the “LCG ID bitmap” field in some other embodiments of the present disclosure.

The “LCG ID bitmap” field may include one or more indicators, each of which may be associated with a corresponding LCG ID configured for LCHs in the RRC message. The one or more indicators can be arranged according to an ascending order or a descending order of the values of the LCG IDs configured for LCHs in the RRC message. For example, assuming that the wireless node is configured with LCG IDs of 0 to 10 and 20 to 29, the “LCG ID bitmap” field thus includes 21 indicator, for example, indicators #1 to #21 corresponding to LCG IDs 0 to 10 and 20 to 29, respectively. Indicators #1 to #21 may be positioned from indicators #1 to #21 or from indicators #21 to #1 in the LCG ID bitmap″ field. Other methods for arranging the one or more indicators can also be employed and are not precluded from the present disclosure.

For the long BSR format and pre-emptive BSR format, each of the one or more indicators may indicate a presence or absence of a buffer size field for the corresponding LCG ID in the BSR MAC CE format 700. Each of the one or more indicators may include 1 bit. For example, an indicator setting to 1 may indicate that the “Buffer Size” field for the corresponding LCG ID is reported; an indicator setting to 0 may indicate that the “Buffer Size” field for the corresponding LCG ID is not reported; or vice versa. For instance, indicator #21 setting to 1 may indicate that a “Buffer Size” field for LCG ID 29 is included in the BSR MAC CE format 700.

For the Long Truncated BSR format, each of the one or more indicators may indicate whether an LCG having the corresponding LCG ID has data available or not. Each of the one or more indicators may include 1 bit. For example, an indicator setting to 1 may indicate that the LCG having a corresponding LCG ID has data available; an indicator setting to 0 may indicate that the LCG having a corresponding LCG ID does not data available; or vice versa. For instance, indicators #1 setting to 1 may indicate that the LCG having LCG ID 0 has data available.

The “Buffer Size” field may have the same definitions as the corresponding fields described above with respect to FIGS. 4 and 6. For example, for the long BSR format and long truncated BSR format, a “Buffer Size” field may identify the amount of data available across all LCHs of a corresponding LCG ID. For the pre-emptive BSR format, the “Buffer Size” field may indicate the amount of data expected to arrive at all the LCHs of a corresponding LCG. The length of a “Buffer Size” field may be 8 bits. The “Buffer Size” fields may be included in an ascending (or descending) order of the corresponding LCG IDs. For the long truncated BSR format, the number of “Buffer Size” fields included is maximized, while not exceeding the number of padding bits.

For example, although the “LCG ID bitmap” field may indicate that there are 8 LCGs (e.g., having the LCG IDs of 0 to 7) having data available, due to the number of padding bits, only a maximum of 3 “Buffer Size” fields can be included in the padding BSR. For example, the “Buffer Size” fields for the LCGs having LCG IDs of 0 to 2 (i.e., an ascending order of LCG IDs) or the “Buffer Size” fields for the LCGs having LCG IDs of 7 to 5 (i.e., a descending order of LCG IDs) may be included in the long truncated BSR MAC CE.

Referring to FIG. 7, for the long BSR format and pre-emptive BSR format, assuming that among the indicators #1 to #21 in the “LCG ID bitmap” field, N indicators indicate the presence of a “Buffer Size” field for the corresponding LCG, the BSR MAC CE format 700 may include N “Buffer Size” fields, which can occupy “Oct 4” to “Oct N+3” in FIG. 7. The N “Buffer Size” fields may be arranged according to the ascending (or descending) order of the LCG IDs of the corresponding LCGs.

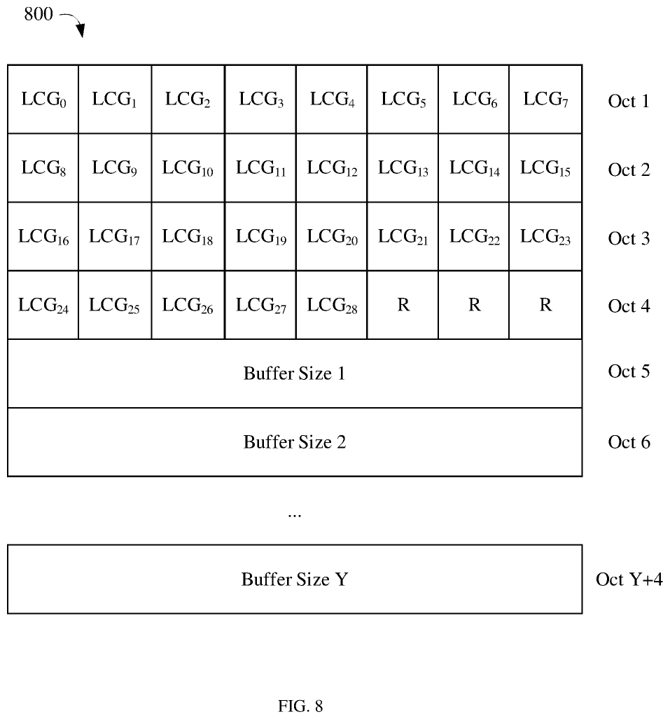

FIG. 8 illustrates an exemplary BSR MAC CE format 800 in accordance with some embodiments of the present disclosure. The BSR MAC CE format 800 can be used as long BSR format, long truncated BSR format, or pre-emptive BSR format.

As shown in FIG. 8, the BSR MAC CE format 800 can be octet aligned and can have a variable size. The BSR MAC CE format 800 may include several fields such as some “LCGᵢ” field, one or more “R” fields (optional) and some “Buffer Size” fields.

Although there are a plurality of “Buffer Size” fields in the example of FIG. 8, it should be appreciated by persons skilled in the art that the BSR MAC CE format 800 may not include any “Buffer Size” fields or may include only one “Buffer Size” field in some other embodiments of the present disclosure. For example, when the padding bits cannot accommodate a “Buffer Size” field or can at most accommodate one “Buffer Size” field.

As stated above, an RRC message may configure an LCG ID for an LCH of a wireless node. The number of the “LCGᵢ” fields can be variable based on the number of LCG IDs configured for LCHs in such RRC message. For example, although up to 64 LCGs may be supported (e.g., the LCG IDs may be indexed from 0 to 63 or 1 to 64), a wireless node may be configured with only 29 LCG IDs for its LCHs. The BSR MAC CE format 800 may include 29 “LCGᵢ” fields, which are denoted as “LCG₀” to “LCG₂₈” in FIG. 8 (or denoted as “LCG₁,” to “LCG₂₉”) in some other embodiments), and occupies the first three bytes (denoted as “Oct 1” to “Oct 3” in FIG. 8) and the first 5 bits of the fourth byte (denoted as “Oct 4” in FIG. 8) of the BSR MAC CE format 800. The BSR MAC CE format 800 may further include three “R” fields such that a combination of the “LCGᵢ” fields and the “R” fields is byte aligned.

In some other embodiments of the present disclosure, the BSR MAC CE format 800 may include fewer or more “R” fields. For example, when the number of LCG IDs which have been actually used to configure the LCHs of the wireless node is a multiple of 8, no “R” field is included in the BSR MAC CE format 800. Although the “R” fields are added after all the “LCGᵢ” fields in the example of FIG. 8, it should be appreciated by persons skilled in the art that the “R” fields may be positioned before any “LCGᵢ” fields (i.e., at the beginning of “Oct 1”) in some other embodiments of the present disclosure.

Each of the “LCGᵢ” fields may be associated with a corresponding LCG ID configured for LCHs in the RRC message. The plurality of the “LCGᵢ” fields can be arranged according to an ascending order or a descending order of the values of the LCG IDs configured for LCHs in the RRC message. For example, assuming that the wireless node is configured with LCG IDs of 0 to 18 and 20 to 29, the “LCG₀” to “LCG₂₈” fields may respectively correspond to LCG IDs of 0 to 18 and 20 to 29 (ascending order). Alternatively, the “LCG₂₈” to “LCG₀” fields may respectively correspond to LCG IDs of 0 to 18 and 20 to 29 (descending order). Other methods for arranging the one or more indicators can also be employed and are not precluded from the present disclosure.

For the long BSR format and pre-emptive BSR format, each “LCGᵢ” field may indicate a presence or absence of a buffer size field for the corresponding LCG ID in the BSR MAC CE format 800. Each “LCGᵢ” field may include 1 bit. For example, an “LCGᵢ” field setting to 1 may indicate that the “Buffer Size” field for the corresponding LCG ID is reported; an “LCGᵢ” field setting to 0 may indicate that the “Buffer Size” field for the corresponding LCG ID is not reported; or vice versa. For instance, the “LCG₀” field setting to 1 may indicate that a “Buffer Size” field for LCG ID 0 (ascending order) or LCG ID 29 (descending order) is included in the BSR MAC CE format 800.

For the Long Truncated BSR format, each “LCGᵢ” field may indicate whether an LCG having the corresponding LCG ID has data available or not. Each “LCGᵢ” field may include 1 bit. For example, an “LCGᵢ” field setting to 1 may indicate that the LCG having a corresponding LCG ID has data available; an “LCGᵢ” field setting to 0 may indicate that the LCG having a corresponding LCG ID does not have data available; or vice versa. For instance, the “LCG₀” field setting to 1 may indicate that the LCG having LCG ID 0 (ascending order) or LCG ID 29 (descending order) has data available.

The “Buffer Size” field may have the same definitions as the corresponding fields described above with respect to FIGS. 4, 6, and 7. For example, for the long BSR format and long truncated BSR format, a “Buffer Size” field may identify the amount of data available across all LCHs of a corresponding LCG ID. For the pre-emptive BSR format, the “Buffer Size” field may indicate the amount of data expected to arrive at all the LCHs of a corresponding LCG. The length of a “Buffer Size” field may be 8 bits. The “Buffer Size” fields may be included in an ascending (or descending) order of the corresponding LCG IDs. For the long truncated BSR format, the number of “Buffer Size” fields included is maximized, while not exceeding the number of padding bits.

For example, although the 29 “LCGᵢ” fields may indicate that there are 8 LCGs (e.g., having the LCG IDs of 0 to 7) having data available, due to the number of padding bits, only a maximum of 3 “Buffer Size” fields can be included in the padding BSR. For example, the “Buffer Size” fields for the LCGs having LCG IDs of 0 to 2 (i.e., an ascending order of LCG IDs) or the “Buffer Size” fields for the LCGs having LCG IDs of 7 to 5 (i.e., a descending order of LCG IDs) may be included in the long truncated BSR MAC CE.

Referring to FIG. 8, for the long BSR format and pre-emptive BSR format, assuming that among “LCG₀” to “LCG₂₈” fields, Y “LCGᵢ” fields indicate the presence of a “Buffer Size” field for the corresponding LCG, the BSR MAC CE format 800 may include Y “Buffer Size” fields, which can occupy “Oct 5” to “Oct Y+4” in FIG. 8. The Y “Buffer Size” fields may be arranged according to the ascending (or descending) order of the LCG IDs of the corresponding LCGs.

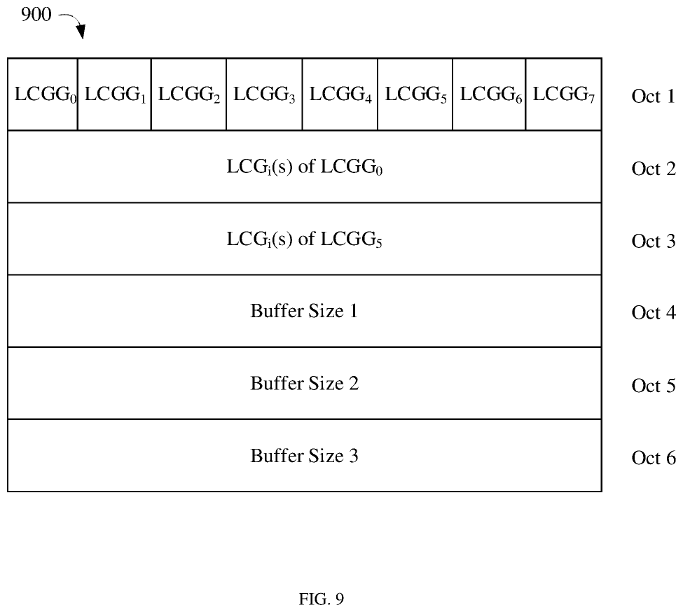

FIG. 9 illustrates an exemplary BSR MAC CE format 900 in accordance with some embodiments of the present disclosure. The BSR MAC CE format 900 can be used as long BSR format, long truncated BSR format, or pre-emptive BSR format.

As shown in FIG. 9, the BSR MAC CE format 900 can be octet aligned and can have a variable size. The BSR MAC CE format 900 may include several fields such as some “LCGGⱼ” fields, some “LCGᵢ” fields, and some “Buffer Size” fields.

Although there are a plurality of “Buffer Size” fields in the example of FIG. 9, it should be appreciated by persons skilled in the art that the BSR MAC CE format 900 may not include any “Buffer Size” fields or may include only one “Buffer Size” field in some other embodiments of the present disclosure. For example, when the padding bits cannot accommodate a “Buffer Size” field or can at most accommodate one “Buffer Size” field.

Each LCGGⱼ field may occupy 1 bit, and may indicate a presence or absence of a corresponding group of LCG fields in the BSR MAC CE format 900. For example, an LCGGⱼ field setting to 1 may indicate that at least one LCG associated with the LCGG field has data to be reported; an LCGGⱼ field setting to 0 may indicate that all LCGs associated with the LCGG field do not have data to be reported; or vice versa.

The number of the “LCGGⱼ” fields may be determined based on the maximum number of LCG IDs and the number of LCG IDs an LCGG associated with. The maximum number of LCG IDs may be set to 8, 16, 32, etc. The number of the LCG IDs an LCGG associated with can be set to 4, 8, 16, etc.

For example, assuming that a maximum number of 64 LCGs (e.g., having LCG IDs from 0 to 63) are supported and the number of LCGs an LCGG associated with is 8, the BSR MAC CE format 900 may include 8 “LCGGⱼ” fields, which can be denoted as “LCGG₀” to “LCGG₇.” Each LCGGⱼ may be associated with 8 LCGᵢ, wherein i=8j, 8j+1, 8j+2 . . . 8j+7 and j is from 0 to 7. For instance, “LCGG₀” can be associated with LCGs having LCG IDs from 0 to 7, and “LCGG₁,” can be associated with LCGs having LCG IDs from 8 to 15, and so on.

Although the LCGG index (j) is started from 0 in the example of FIG. 9, it should be appreciated by persons skilled in the art that the LCGG index (j) may start from 1 in some other embodiments of the present disclosure. In these embodiments, each LCGGⱼ may be associated with 8 LCGᵢ, wherein i=8j−8, 8j−7, 8j−6 . . . 8j−1 and j is from 1 to 8.

The “LCGGⱼ” fields can be arranged in the BSR MAC CE format 900 according to the ascending order or descending order of the values of the index (j) of the “LCGGⱼ” fields. For example, as shown in FIG. 9, the “LCGGⱼ” fields in the BSR MAC CE format 900 can be arranged from “LCGG₀” to “LCGG₇” according to the ascending order of LCGG indexes and occupies “Oct 1” in FIG. 9.

In some other embodiments of the present disclosure, the number of the “LCGGⱼ” fields may not be a multiple of 8, the BSR MAC CE format 900 may further include at least one “R” field such that a combination of the “LCGGⱼ” fields and the at least one “R” field is byte aligned. The at least one “R” field may be added after the end of all “LCGGⱼ” fields or before any “LCGGⱼ” fields (e.g., at the beginning of “Oct 1”).

For example, assuming that “LCGG₀” and “LCGG₅” fields may indicate a presence of the corresponding groups of LCG fields and the remaining LCGGⱼ fields may indicate an absence of the corresponding groups of LCG fields, the BSR MAC CE format 900 may further include two groups of “LCGᵢ” fields corresponding to the “LCGG₀” and “LCGG₅” fields, respectively. In the example of FIG. 9, the number of the LCG IDs an LCGG associated with is 8, so the groups of “LCGᵢ” fields are byte aligned. In some other embodiments of the present disclosure, at least one “R” field may be included in the BSR MAC CE format 900 such that a combination of the groups of “LCGᵢ” fields and the at least one “R” field is byte aligned.

The two groups of “LCGᵢ” fields may be arranged according to the LCGG index (j) of the associated LCGG₅, e.g., in an ascending or descending order of the corresponding the LCGG index. For example, in the example of FIG. 9, the group of “LCGᵢ” fields associated with LCGG₀ (denoted as “LCGᵢ (s) of LCGG₀” and occupies ‘Oct 2’ in FIG. 9) may be arranged before the one associated with LCGG₅ (denoted as “LCGᵢ (s) of LCGG₅” and occupies ‘Oct 3’ in FIG. 9) in the BSR MAC CE format 900. “LCGᵢ (s) of LCGG₀” may include LCG₀ field to LCG₇ field, which may correspond to the LCGs having LCG IDs of 0 to 7, respectively. “LCGᵢ (s) of LCGG₅” may include LCG₄₀ field to LCG₄₇ field, which may correspond to the LCGs having LCG IDs of 40 to 47, respectively. The LCGs of a LCGG may be arranged according to the ascending or descending order of the values of the corresponding LCG IDs of the member LCGs.

Other methods for arranging the “LCGGⱼ” fields, the groups of “LCGᵢ” fields, and the LCGs of a LCGG can also be employed and are not precluded from the present disclosure.

The “LCGᵢ” field may have the same definitions as the corresponding fields described above with respect to FIGS. 4 and 6. For example, for the long BSR format and pre-emptive BSR format, an “LCGᵢ” field may indicate the presence or absence of a “Buffer Size” field for the logical channel group i. For the Long truncated BSR format, the “LCGᵢ” field may indicate whether logical channel group i has data available or not.

For instance, for a long BSR format, “LCGᵢ (s) of LCGG₀” and “LCGᵢ (s) of LCGG₅” may respectively indicate “00010001” and “00001000.” That is, the LCG₃ field, LCG₇ field, and LCG₄₄ field have a value of 1, which may mean that three “Buffer Size” fields for LCG 3, LCG 7, and LCG 44 (e.g., LCGs having LCG IDs of 3, 7, and 44) are presented in the BSR MAC CE format 900.

The “Buffer Size” field may have the same definitions as the corresponding fields described above with respect to FIGS. 4 and 6. For example, for the long BSR format and long truncated BSR format, a “Buffer Size” field may identify the amount of data available across all LCHs of a corresponding LCG ID. For the pre-emptive BSR format, the “Buffer Size” field may indicate the amount of data expected to arrive at all the LCHs of a corresponding LCG. The length of a “Buffer Size” field may be 8 bits. The “Buffer Size” fields may be included in an ascending (or descending) order of the corresponding LCG IDs. For the long truncated BSR format, the number of “Buffer Size” fields included is maximized, while not exceeding the number of padding bits.

For example, the three “Buffer Size” fields for LCG 3, LCG 7, and LCG 44 may be arranged according to the ascending or descending order of the values of the LCG IDs. For instance, “Buffer Size 1” to “Buffer Size 3” in FIG. 9 may respectively correspond to LCG 3, LCG 7, and LCG 44. Alternatively, “Buffer Size 1” to “Buffer Size 3” in FIG. 9 may respectively correspond to LCG 44, LCG 7, and LCG 3. “Buffer Size 1” to “Buffer Size 3” can occupy “Oct 4” to “Oct 6” in FIG. 9.

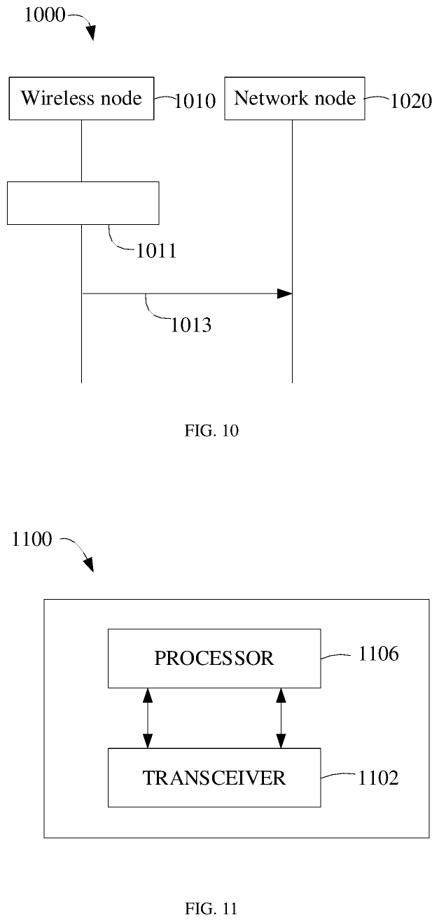

FIG. 10 illustrates a flow chart of an exemplary procedure 1000 of wireless communications in accordance with some embodiments of the present disclosure. Details described in all of the foregoing embodiments of the present disclosure are applicable for the embodiments shown in FIG. 10. It should be appreciated by persons skilled in the art that the sequence of the operations in exemplary procedure 1000 may be changed and some of the operations in exemplary procedure 1000 may be eliminated or modified, without departing from the spirit and scope of the disclosure.

Referring to FIG. 10, wireless node 1010 may function as a UE or an IAB node, and network node 1020 may function as a BS or another IAB node.

In operation 1011, wireless node 1010 may generate a BSR MAC CE. In some embodiments of the present disclosure, the BSR MAC CE may have a format as described with respect to one of FIGS. 3-9. In some examples, wireless node 1010 may receive an RRC message configuring a LCG ID for its LCH (e.g., by the logicalChannelGroup IE). For instance, the RRC message may configure one or more LCHs of wireless node 1010 and may include one or more LCG IDs corresponding to the one or more LCH. The RRC message may be from network node 1020. In some embodiments of the present disclosure, the BSR MAC CE may be generated based on the received RRC message.

In some embodiments of the present disclosure, in response to the number of LCG IDs configured for LCHs in the RRC message being greater than a threshold for LCG number (e.g., 8), wireless node 1010 may generate the BSR MAC CE as described above with respect to one of FIGS. 5-9. For example, for the BSR procedure, when only one LCG has data to be reported, wireless node 1010 may generate the BSR MAC CE as described with respect to FIG. 5; and when more than one LCG has data to be reported, wireless node 1010 may generate the BSR MAC CE as described with respect to one of FIGS. 6-9. For the pre-emptive BSR procedure, wireless node 1010 may generate the BSR MAC CE as described with respect to one of FIGS. 6-9.

Otherwise, in response to the number of LCG IDs configured for LCHs in the RRC message being less than or equal to the threshold for LCG number, wireless node 1010 may generate the BSR MAC CE as described above with respect to, for example, FIGS. 3 and 4, even when the max number of LCGs (e.g., 64 or 256) is greater than the threshold for LCG number. For example, for the BSR procedure, when only one LCG has data to be reported, wireless node 1010 may generate the BSR MAC CE as described with respect to FIG. 3; and when more than one LCG has data to be reported, wireless node 1010 may generate the BSR MAC CE as described with respect to FIG. 4. For the pre-emptive BSR procedure, wireless node 1010 may generate the BSR MAC CE as described with respect to FIG. 4. In the case that the max number of LCGs is greater the threshold for LCG number and the BSR MAC CE format 400 is applied, the “LCGᵢ” field in the BSR MAC CE may have the same definition as that the “LCGᵢ” field in FIG. 8. For example, “LCGᵢ” fields in the BSR MAC CE format 400 may correspond to configured LCGs in the RRC message and be arranged according to the ascending or descending order of the values of the corresponding LCG IDs.

In some embodiments of the present disclosure, BSR MAC CE formats that can support a maximum number of more than 8 LCGs (e.g., 16 or 32 LCGs) may be defined. In response to the number of LCG IDs configured for LCHs in the RRC message being less than or equal to the threshold for LCG number (which may be 16 or 32), wireless node 1010 may generate the BSR MAC CE according to such BSR MAC CE formats, even when the max number of LCGs (e.g., 64 or 256) is greater than the threshold for LCG number.

In some embodiments of the present disclosure, in response to the value of an LCG ID configured for LCHs in the RRC message being greater than a threshold for LCG ID (e.g., 7), wireless node 1010 may generate the BSR MAC CE as described above with respect to one of FIGS. 5-9. For example, for the BSR procedure, when only one LCG has data to be reported, wireless node 1010 may generate the BSR MAC CE as described with respect to FIG. 5; and when more than one LCG has data to be reported, wireless node 1010 may generate the BSR MAC CE as described with respect to one of FIGS. 6-9. For the pre-emptive BSR procedure, wireless node 1010 may generate the BSR MAC CE as described with respect to one of FIGS. 6-9.

Otherwise, in response to all the values of the LCG IDs configured for the LCHs in the RRC message being less than or equal to the threshold for LCG ID, wireless node 1010 may generate the BSR MAC CE as described above with respect to one of FIGS. 3 and 4, even when the max number of LCGs is greater than the threshold for LCG number. For example, for the BSR procedure, when only one LCG has data to be reported, wireless node 1010 may generate the BSR MAC CE as described with respect to FIG. 3; and when more than one LCG has data to be reported, wireless node 1010 may generate the BSR MAC CE as described with respect to FIG. 4. For the pre-emptive BSR procedure, wireless node 1010 may generate the BSR MAC CE as described with respect to FIG. 4.

In some embodiments of the present disclosure, in response to the logicalChannelGroup IE configured for an LCH in the RRC message having a maximum value greater than the threshold for LCG ID (e.g., 7), wireless node 1010 may generate the BSR MAC CE as described above with respect to one of FIGS. 5-9. For example, for the BSR procedure, when only one LCG has data to be reported, wireless node 1010 may generate the BSR MAC CE as described with respect to FIG. 5; and when more than one LCG has data to be reported, wireless node 1010 may generate the BSR MAC CE as described with respect to one of FIGS. 6-9. For the pre-emptive BSR procedure, wireless node 1010 may generate the BSR MAC CE as described with respect to one of FIGS. 6-9.

Otherwise, in response to all logicalChannelGroup IEs configured for the LCHs in the RRC message having a maximum value less than or equal to the threshold for LCG ID, wireless node 1010 may generate the BSR MAC CE as described above with respect to one of FIGS. 3 and 4. For example, for the BSR procedure, when only one LCG has data to be reported, wireless node 1010 may generate the BSR MAC CE as described with respect to FIG. 3; and when more than one LCG has data to be reported, wireless node 1010 may generate the BSR MAC CE as described with respect to FIG. 4. For the pre-emptive BSR procedure, wireless node 1010 may generate the BSR MAC CE as described with respect to FIG. 4.

In some embodiments of the present disclosure, in response to the maximum number of the LCG supported by wireless node being greater than a threshold (e.g., 8) or the maximum value of the LCG ID being greater than a threshold (e.g., 7), wireless node 1010 may generate the BSR MAC CE as described above with respect to one of FIGS. 5-9. For example, for the BSR procedure, when only one LCG has data to be reported, wireless node 1010 may generate the BSR MAC CE as described with respect to FIG. 5; and when more than one LCG has data to be reported, wireless node 1010 may generate the BSR MAC CE as described with respect to one of FIGS. 6-9. For the pre-emptive BSR procedure, wireless node 1010 may generate the BSR MAC CE as described with respect to one of FIGS. 6-9.

Otherwise, in response to the maximum number of the LCG supported by wireless node being less than or equal to the threshold or the maximum value of the LCG ID being less than or equal to the threshold, wireless node 1010 may generate the BSR MAC CE as described above with respect to one of FIGS. 3 and 4. For example, for the BSR procedure, when only one LCG has data to be reported, wireless node 1010 may generate the BSR MAC CE as described with respect to FIG. 3; and when more than one LCG has data to be reported, wireless node 1010 may generate the BSR MAC CE as described with respect to FIG. 4. For the pre-emptive BSR procedure, wireless node 1010 may generate the BSR MAC CE as described with respect to FIG. 4.

In operation 1013, wireless node 1010 may transmit the generated BSR MAC CE to network node 1020. In some examples, wireless node 1010 may be a UE and network node 1020 may be the serving BS or an IAB node connected to the UE. In some examples, wireless node 1010 may be an IAB node and network node 1020 may be its parent node, e.g., the serving BS (e.g., IAB-donor-DU) or the parent IAB node.

FIG. 11 illustrates a block diagram of an exemplary apparatus 1100 according to some embodiments of the present disclosure.

As shown in FIG. 11, the apparatus 1100 may include at least one processor 1106 and at least one transceiver 1102 coupled to the processor 1106. The apparatus 1100 may be a UE, an IAB node, or a BS.

Although in this figure, elements such as the at least one transceiver 1102 and processor 1106 are described in the singular, the plural is contemplated unless a limitation to the singular is explicitly stated. In some embodiments of the present application, the transceiver 1102 may be divided into two devices, such as a receiving circuitry and a transmitting circuitry. In some embodiments of the present application, the apparatus 1100 may further include an input device, a memory, and/or other components.

In some embodiments of the present application, the apparatus 1100 may be a UE. The transceiver 1102 and the processor 1106 may interact with each other so as to perform the operations with respect to the UE and wireless node described in FIGS. 1-10. In some embodiments of the present application, the apparatus 1100 may be an IAB node. The transceiver 1102 and the processor 1106 may interact with each other so as to perform the operations with respect to the IAB node, the wireless node, and the network node described in FIGS. 1-10. In some embodiments of the present application, the apparatus 1100 may be a BS. The transceiver 1102 and the processor 1106 may interact with each other so as to perform the operations with respect to the BS and the network node described in FIGS. 1-10.

In some embodiments of the present application, the apparatus 1100 may further include at least one non-transitory computer-readable medium.

For example, in some embodiments of the present disclosure, the stored thereon non-transitory computer-readable medium may have computer-executable instructions to cause the processor 1106 to implement the method with respect to the UE and wireless node as described above. For example, the computer-executable instructions, when executed, cause the processor 1106 interacting with transceiver 1102, so as to perform the operations with respect to the UE and wireless node described in FIGS. 1-10.

In some embodiments of the present disclosure, the non-transitory computer-readable medium may have stored thereon computer-executable instructions to cause the processor 1106 to implement the method with respect to the IAB node, the wireless node, and the network node as described above. For example, the computer-executable instructions, when executed, cause the processor 1106 interacting with transceiver 1102, so as to perform the operations with respect to the IAB node, the wireless node, and the network node described in FIGS. 1-10.

In some embodiments of the present disclosure, the non-transitory computer-readable medium may have stored thereon computer-executable instructions to cause the processor 1106 to implement the method with respect to the BS and the network node as described above. For example, the computer-executable instructions, when executed, cause the processor 1106 interacting with transceiver 1102, so as to perform the operations with respect to the BS and the network node described in FIGS. 1-10.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A method performed by a wireless node, the method comprising:
receiving a radio resource control (RRC) message configuring one or more logical channels (LCHs) of the wireless node, wherein the RRC message comprises one or more logical channel group (LCG) IDs corresponding to the one or more LCHs;
generating a second buffer status reporting (BSR) medium access control (MAC) control element (CE) in response to all values of the LCG IDs configured for the LCHs in the RRC message being less than or equal to a first threshold, or generating a first BSR MAC CE in response to a value of an LCG ID configured for LCHs in the RRC message being greater than the first threshold; and
transmitting the first BSR MAC CE to a network node.

2. The method of claim 1, wherein the second BSR MAC CE includes an LCG ID bitmap field, and a size of the LCG ID bitmap field is variable based on a number of LCG IDs configured for LCHs in the RRC message.

3. The method of claim 2, wherein the LCG ID bitmap field includes one or more indicators, and the one or more indicators are associated with the corresponding one or more LCG IDs configured for the one or more LCHs in the RRC message.

4. The method of claim 3, wherein the one or more indicators are arranged according to an ascending order or a descending order of values of the one or more LCG IDs configured for the corresponding one or more LCHs in the RRC message.

5. The method of claim 3, wherein each of the one or more indicators indicates a presence or absence of a buffer size field for the corresponding LCG ID in the second BSR MAC CE, and the buffer size field indicates:
an amount of data available across all LCHs associated with the corresponding LCG ID, or
an amount of data expected to arrive at all the LCHs associated with the corresponding LCG ID.

6. The method of claim 3, wherein each of the one or more indicators indicates whether an LCG having the corresponding LCG ID has data available or not.

7. The method of claim 1, wherein the second BSR MAC CE includes one or more LCG fields, and a number of the LCG fields is variable based on a number of LCG IDs configured for LCHs in the RRC message.

8. The method of claim 7, wherein the one or more fields are associated with the corresponding one or more LCG IDs configured for the one or more LCHs in the RRC message.

9. The method of claim 8, wherein the one or more LCG fields are arranged according to an ascending order or a descending order of values of the one or more LCG IDs configured for the corresponding one or more LCHs in the RRC message.

10. The method of claim 8, wherein each of the one or more LCG fields indicates a presence or absence of a buffer size field for the corresponding LCG ID in the second BSR MAC CE, and the buffer size field indicates:
an amount of data available across all LCHs associated with the corresponding LCG ID, or
an amount of data expected to arrive at all the LCHs associated with the corresponding LCG ID.

11. The method of claim 8, wherein each of the one or more LCG fields indicates whether an LCG having the corresponding LCG ID has data available or not.

12. The method of claim 7, wherein the second BSR MAC CE further includes at least one reserved bit such that a combination of an LCG ID bitmap field and the at least one reserved bit or a combination of the one or more LCG fields and the at least one reserved bit is byte aligned.

13. The method of claim 1, wherein generating the second BSR MAC CE comprises generating the second BSR MAC CE in response to:
a number of LCG IDs configured for LCHs in the RRC message being greater than a first threshold for LCG number;
a value of an LCG ID configured for LCHs in the RRC message being greater than a second threshold for LCG ID; or
an information element of logicalChannelGroup configured for an LCH in the RRC message having a maximum value greater than the second threshold for LCG ID.

14. A wireless node, comprising:
at least one memory; and
at least one processor coupled with the at least one memory and configured to cause the wireless node to:
receive a radio resource control (RRC) message configuring one or more logical channels (LCHs) of the wireless node, wherein the RRC message comprises one or more logical channel group (LCG) IDs corresponding to the one or more LCHs;
generate a second buffer status reporting (BSR) medium access control (MAC) control element (CE) in response to all values of the LCG IDs configured for the LCHs in the RRC message being less than or equal to a first threshold, or generating a first BSR MAC CE in response to a value of an LCG ID configured for LCHs in the RRC message being greater than the first threshold; and
transmit the first BSR MAC CE to a network node.

15. A processor for wireless communication, comprising:
at least one controller coupled with at least one memory and configured to cause the processor to:
receive a radio resource control (RRC) message configuring one or more logical channels (LCHs) of the processor, wherein the RRC message comprises one or more logical channel group (LCG) IDs corresponding to the one or more LCHs;
generate a second buffer status reporting (BSR) medium access control (MAC) control element (CE) in response to all values of the LCG IDs configured for the LCHs in the RRC message being less than or equal to a first threshold, or generating a first BSR MAC CE in response to a value of an LCG ID configured for LCHs in the RRC message being greater than the first threshold; and
transmit the first BSR MAC CE to a network node.

16. The processor of claim 15, wherein the second BSR MAC CE includes an LCG ID bitmap field, and a size of the LCG ID bitmap field is variable based on a number of LCG IDs configured for LCHs in the RRC message.

17. The processor of claim 16, wherein the LCG ID bitmap field includes one or more indicators, and the one or more indicators are associated with the corresponding one or more LCG IDs configured for the one or more LCHs in the RRC message.

18. The processor of claim 17, wherein the one or more indicators are arranged according to an ascending order or a descending order of values of the one or more LCG IDs configured for the corresponding one or more LCHs in the RRC message.

19. The processor of claim 17, wherein each of the one or more indicators indicates a presence or absence of a buffer size field for the corresponding LCG ID in the second BSR MAC CE, and the buffer size field indicates:
an amount of data available across all LCHs associated with the corresponding LCG ID, or
an amount of data expected to arrive at all the LCHs associated with the corresponding LCG ID.

20. A base station, comprising:
at least one memory; and
at least one processor coupled with the at least one memory and configured to cause the base station to:
transmit a radio resource control (RRC) message configuring one or more logical channels (LCHs) of a wireless node, wherein the RRC message comprises one or more logical channel group (LCG) IDs corresponding to the one or more LCHs; and
receive a first buffer status reporting (BSR) medium access control (MAC) control element (CE) from the wireless node UE, wherein the BSR MAC CE is based a value of an LCG ID configured for LCHs in the RRC message being greater than a first threshold.
